(19) United States
(12) Patent Application Publication
(10) Pub. No.: US 2026/0037775 A1
(43) Pub. Date: Feb. 5, 2026

(54) SIGNAL PROCESSING APPARATUS, SIGNAL PROCESSING METHOD, AND PROGRAM

(71) Applicant: SOFTBANK CORP., Tokyo (JP)

(72) Inventors: Yuko ISHIWAKA, Tokyo (JP); Shun OGAWA, Tokyo (JP); Atsuya TANGE, Tokyo (JP)

(21) Appl. No.: 19/267,037

(22) Filed: Jul. 11, 2025

(30) Foreign Application Priority Data
Aug. 5, 2024 (JP) 2024-128643

(51) Int. Cl. G06N 3/045; G06N 3/08

(52) U.S. Cl. CPC G06N 3/045; G06N 3/08

(57) ABSTRACT

A signal processing apparatus includes: an acceptance unit that accepts a time-series signal; an information acquisition unit that, for each buffering time of two or more buffering times, acquires information having a time length corresponding to the buffering time from the time-series signal; a frequency conversion unit that, for each buffering time of the two or more buffering times, performs frequency conversion on the information acquired by the information acquisition unit to acquire an image; a signal transmission unit that, for each buffering time of the two or more buffering times, passes the image acquired by the frequency conversion unit to a neural network, and acquires output information that is based on a signal output from the neural network; and an information output unit that outputs the output information.

### CROSS REFERENCE TO RELATED APPLICATION

This application claims the benefit of priority of Japanese Patent Application Number 2024-128643, filed on Aug. 5, 2024, the entire content of which is hereby incorporated by reference.

### BACKGROUND OF THE INVENTION

### 1. Field of the Invention

The present invention relates to a signal processing apparatus or the like that processes a time-series signal, acquires information, and outputs the information.

### 2. Description of Related Art

In the field of signal processing, conventional techniques such as analyzing time-series data using an AI model to perform frequency analysis, voice recognition, and estimation of the direction from which a sound is coming are widely known. It is also known that converting time-series data into frequency-domain data before inputting it into an AI model results in improved analytical accuracy compared to using the time-series data itself. For this reason, it is common to apply a “window function” with a certain buffering time width to the time-series data in order to extract segments, and then input the resulting frequency-domain data obtained through Fourier transform into an AI model. Such a Fourier transform is called a short-time Fourier transform (STFT) (see Non-Patent Document 1). The AI model here is typically a neural network.

In addition, in order to improve the efficiency of speech learning, there is a speech recognition apparatus that is characterized by including: a creation part that creates multiple signal sequences by performing signal analysis on an input speech signal from different time points; and a learning part that performs learning on each of the multiple signal sequences created by the creation part (see Patent Document 1).

### PRIOR ART DOCUMENT

### Patent Document

Patent Document 1: JP 2009-25480A

### Non-Patent Document

Non-Patent Document 1: “Wikipedia: Tanjikan Furie Henkan (Short-Time Fourier Transform)”, [online], [Retrieved Jul. 24, 2024], Internet [URL: https://ja.wikipedia.org/wiki/%E7%9F%AD%E6%99%82%E9%96%93%E3%83%95%E3%83%BC%E3%83%AA%E3%82%A8%E5%A4%89%E6%8F%9B]

### SUMMARY OF THE INVENTION

### Problem to be Solved by the Invention

However, in conventional time-series signal analysis techniques, time analysis and frequency analysis are in a trade-off relationship due to Heisenberg's uncertainty principle. In other words, in conventional techniques, there is a problem in which increasing the resolution of frequency analysis results in a decrease in the resolution of time analysis, and increasing the resolution of time analysis results in a decrease in the resolution of frequency analysis. In addition, in conventional time-series signal analysis techniques, there is a problem in that the selection of the window width and window function, both of which significantly affect the analysis results, depends on the signal data to be analyzed and requires the analyst's specialized knowledge and experience.

In view of the above problems, the inventor(s) conceived the idea of reproducing, using an AI model, the biological mechanism by which the human auditory neural system extracts sound features at different time scales through three types of cells (bushy cells, stellate cells, and octopus cells). As a result, the present invention proposes a signal processing apparatus that models a neural cell network capable of extracting different sound features, thereby solving the aforementioned problems, and includes an AI model for general-purpose time-series signal analysis adaptable to a wide range of tasks.

### Means for Solving the Problems

A signal processing apparatus according to a first aspect of the present invention is a signal processing apparatus including: an acceptance unit that accepts a time-series signal; an information acquisition unit that, for each buffering time of two or more buffering times, acquires information having a time length corresponding to the buffering time from the time-series signal; a frequency conversion unit that, for each buffering time of the two or more buffering times, performs frequency conversion on the information acquired by the information acquisition unit to acquire an image; a signal transmission unit that, for each buffering time of the two or more buffering times, passes the image acquired by the frequency conversion unit to a neural network, and acquires output information that is based on a signal output from the neural network; and an information output unit that outputs the output information.

With this configuration, it is possible to appropriately perform both time domain analysis and frequency domain analysis on a time-series signal.

A signal processing apparatus according to a second aspect of the present invention is the signal processing apparatus according to the first aspect of the invention, further including: a learning unit that, for each buffering time of the two or more buffering times, passes the image acquired by the frequency conversion unit to a sub neural network corresponding to the buffering time, updates the two or more sub neural networks, and merges the two or more updated sub-neural networks to form one neural network, wherein, for each buffering time of the two or more buffering times, the signal transmission unit passes the image acquired by the frequency conversion unit to the one neural network, and acquires output information acquired from the one neural network.

With this configuration, it is possible to appropriately perform both time domain analysis and frequency domain analysis on a time-series signal.

A signal processing apparatus according to a third aspect of the present invention is the signal processing apparatus according to the first aspect of the invention, wherein, for each buffering time of the two or more buffering times, the signal transmission unit passes the image acquired by the frequency conversion unit to a neural network for the buffering time, and acquires output information output from the two or more neural networks, and the information output unit outputs the two or more pieces of output information acquired by the signal transmission unit or one piece of output information that is based on the two or more pieces of output information acquired by the signal transmission unit.

With this configuration, it is possible to appropriately perform both time domain analysis and frequency domain analysis on a time-series signal.

A signal processing apparatus according to a fourth aspect of the present invention is the signal processing apparatus according to the third aspect of the invention, wherein, for each buffering time of the two or more buffering times, the signal transmission unit passes the image acquired by the frequency conversion unit to a sub neural network for the buffering time, acquires output information output from the two or more sub neural networks, passes the two or more pieces of output information to the one neural network, and acquires output information output from the neural network, and the information output unit outputs the output information acquired by the signal transmission unit. With this configuration, it is possible to appropriately perform both time

domain analysis and frequency domain analysis on a time-series signal.

A signal processing apparatus according to a fifth aspect of the present invention is the signal processing apparatus according to any one of the first to fourth aspects of the invention, wherein the acceptance unit accepts two or more time-series signals, for each time-series signal of the two or more time-series signals, and for each buffering time of the two or more buffering times, the information acquisition unit acquires information having a time length corresponding to the buffering time from the time-series signal, and for each buffering time of the two or more buffering times, the frequency conversion unit performs frequency conversion on the information acquired by the information acquisition unit to acquire an image.

With this configuration, it is possible to appropriately perform both time domain analysis and frequency domain analysis on a time-series signal.

A signal processing apparatus according to a sixth aspect of the present invention is the signal processing apparatus according to any one of the first to fifth aspects of the invention, wherein the two or more buffering times are three or more buffering times, and three buffering times of the three or more buffering times respectively have time lengths corresponding to long-term, medium-term, and short-term time scales such as time scales respectively corresponding to bushy cells, stellate cells, and octopus cells included in auditory nerves of humans.

With this configuration, by utilizing a model that is based on the auditory nerve system of living organisms, it is possible to more appropriately perform both time domain analysis and frequency domain analysis on a time-series signal.

A signal processing apparatus according to a seventh aspect of the present invention is the signal processing apparatus according to any one of the first to sixth aspects of the invention, wherein the time-series signal is an audio signal, and the output information includes one of: a frequency analysis result for the audio signal; a voice recognition result for the audio signal; a sound source separation result for the audio signal; and a sound source direction estimation result for the audio signal.

With this configuration, it is possible to output one of: an appropriate frequency analysis result; an appropriate voice recognition result; an appropriate sound source separation result; and an appropriate sound source direction estimation result, for a time-series audio signal.

### Advantageous Effect of the Invention

With the signal processing apparatus according to the present invention, it is possible to appropriately perform both the time domain analysis and the frequency domain analysis on a time-series signal.

### BRIEF DESCRIPTION OF THE DRAWINGS

FIG. 1 is a block diagram of a signal processing apparatus 1 according to a first embodiment.

FIG. 2 is a flowchart illustrating an example of operation of the signal processing apparatus 1 according to the same.

FIG. 3 is a flowchart illustrating an example of image acquisition processing according to the same.

FIG. 4 is a flowchart illustrating an example of learning processing according to the same.

FIG. 5 is a flowchart illustrating a first example of output information acquisition processing according to the same.

FIG. 6 is a flowchart illustrating a second example of output information acquisition processing according to the same.

FIG. 7 is a flowchart illustrating a third example of output information acquisition processing according to the same.

FIG. 8 is a schematic diagram illustrating a specific examples of the operation of the signal processing apparatus 1 according to the same.

FIG. 9 is a schematic diagram illustrating a specific examples of the operation of the signal processing apparatus 1 according to the same.

FIG. 10 is a block diagram of a computer system according to the same.

### DETAILED DESCRIPTION OF THE INVENTION

Hereinafter, embodiments of a signal processing apparatus and so on will be described with reference to the drawings. Note that in the embodiments, constituent elements with the same reference signs perform similar operations, and therefore, repeated descriptions thereof may be omitted.

### First Embodiment

The present embodiment describes a signal processing apparatus that accepts a time series signal, acquires, for each buffering time of two or more buffering times, a piece of information corresponding to the buffering time from the time-series signal, performs frequency conversion on each of the pieces of information thus acquired, thereby acquiring two or more images, passes each of the two or more images to a neural network, acquires output information that is based on an output from the neural network, and outputs the output information.

The present embodiment describes a signal processing apparatus having a learning function that, for each buffering time of two or more buffering times, passes an image corresponding to the buffering time to a sub-neural network corresponding to the buffering time, and combines the two or more sub-neural networks to form a single neural network.

The present embodiment describes a signal processing apparatus that, for each buffering time of the two or more buffering times, passes an image to a sub-neural network corresponding to the buffering time, acquires an output from each of the two or more sub-neural networks, and outputs information that is based on the outputs from the two or more sub-neural networks.

The present embodiment describes a signal processing apparatus that accepts two or more time-series signals, acquires output information that is based on the two or more time-series signals, and outputs the output information.

The present embodiment describes a signal processing apparatus having a configuration that emulates a human auditory nervous system.

In this specification, the state in which information X is associated with information Y means that the information Y can be acquired from the information X or the information X can be acquired from the information Y, and there is no limitation on the method for associating the information. The information X and the information Y may be linked to each other or in the same buffer. The information X may be contained in the information Y, or the information Y may be contained in the information X, for example.

In addition, in this specification, selecting or determining information Z refers to actions such as acquiring information Z, acquiring a pointer to information Z, acquiring an ID of information Z, or setting a flag on information Z, and there is no limitation as long as information Z can be accessed.

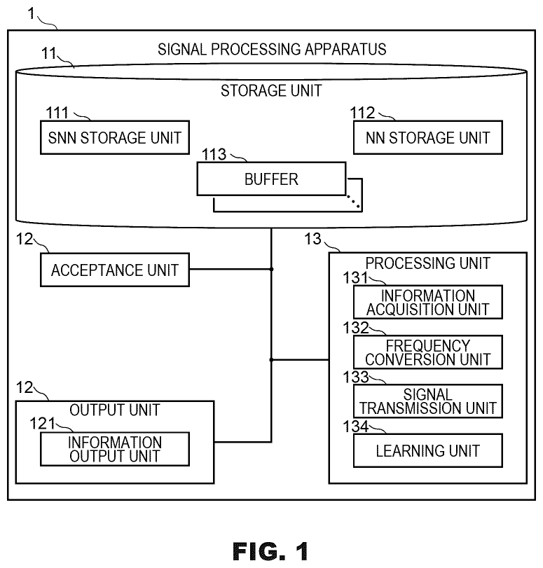

FIG. 1 is a block diagram of a signal processing apparatus 1 according to the present embodiment. The signal processing apparatus 1 is an apparatus that accepts a time-series signal and outputs output information. The signal processing apparatus 1 may be a terminal, or a server that receives a time-series signal from a terminal apparatus (not shown) and transmits output information to the terminal apparatus or another apparatus. When the signal processing apparatus 1 is a terminal, the signal processing apparatus 1 is, for example, a so-called personal computer, a smartphone, or a tablet terminal, but there is no limitation on the type thereof. When the signal processing apparatus 1 is a server, the signal processing apparatus 1 is, for example, a cloud server or an ASP server, but there is no limitation on the type thereof.

The signal processing apparatus 1 includes a storage unit 11, an acceptance unit 12, a processing unit 13, and an output unit 14. The storage unit 11 includes an SNN storage unit 111, an NN storage unit 112, and two or more buffers 113. The processing unit 13 includes an information acquisition unit 131, a frequency conversion unit 132, a signal transmission unit 133, and a learning unit 134. The output unit 14 includes an information output unit 135.

The storage unit 11 included in the signal processing apparatus 1 is a storage area. The storage unit 11 may include two or more types of recording media (e.g., a non-volatile recording medium and a volatile recording medium). The storage unit 11 stores various kinds of information. Examples of the various kinds of information include two or more sub-neural networks, which will be described later, and a neural network, which will be described later.

The SNN storage unit 111 stores two or more sub-neural networks (hereinafter referred to as “SNNs” when appropriate). Each of the two or more sub-neural networks is associated with a different buffering time. Each SNN also has a neural network structure. A neural network may also be called a neural network. For example, two or more SNNs are merged to form a neural network in the NN storage unit 112.

Note that the buffering time is the time length of information extracted from a time-series signal. The buffering time is, for example, the time width of a window function.

The NN storage unit 112 stores a neural network (hereinafter referred to as “NN” when appropriate).

Note that there is no limitation on the activation functions and structures of the nodes included in the NN and the SNNs. The edges included in the NN and the SNNs correspond to weights, for example. Each of the NN and the SNNs typically includes an input layer, an intermediate layer (hidden layer), and an output layer. The neural network type of the NN and the SNNs may be, for example, a feedforward neural network (FFNN), a convolutional neural network (CNN), a recurrent neural network (RNN), a spiking neural network (SNN), or the like, but there is no limitation. The NN and the SNNs are typically neural networks that can be used in so-called deep learning. Neural networks that can be used in deep learning may include the neural networks described above.

Each of the NN and the SNNs is typically a network that accepts an image feature vector at the input layer thereof and outputs output information or information that serves as the basis for the output information, which will be described later, from the output layer thereof.

For example, each of the NN and the SNNs is an AI model that accepts an image feature vector (described later) that is based on an audio signal, which is a time-series signal, and outputs output information, which is one of: a frequency analysis result for the audio signal; a voice recognition result for the audio signal; a sound source separation result for the audio signal; and a sound source direction estimation result for the audio signal, or a signal that is the basis for the output information.

For example, each of the NN and the SNNs is an AI model that accepts an image feature vector (described later) that is based on a video signal, which is a time-series signal, and outputs output information, which is a video summary for the video signal or the recognition result of an object in the video, or a signal that is the basis for the output information.

The storage unit 11 includes a buffer 113(1), a buffer 113(2), . . . , and a buffer 113(N) (N is a natural number greater than or equal to 2). Each of the two or more buffers 113 corresponds to a buffering time. Each of the buffers 113 may be a volatile recording medium such as a memory or a cache, or a non-volatile recording medium such as a hard disk or an SSD. Each of the two or more buffers 113 in the storage unit 11 is associated with a different buffering time. Note that two or more buffers 113 may be associated with one buffering time.

The acceptance unit 12 accepts various kinds of instructions and information. Examples of the various kinds of instructions include a learning instruction and an output instruction. The learning instruction is an instruction to perform learning and update the SNNs or the NN. The learning instruction may include a time-series signal. The output instruction is an instruction to acquire output information based on a time-series signal and output the output information. The output instruction may include a time-series signal.

The acceptance unit 12 accepts a time-series signal. The acceptance unit 12 may accept two or more time-series signals.

A time-series signal is data that changes over time. Examples of time-series signals include audio data, moving images, economic data such as stock prices and exchange rates, meteorological data such as temperature and precipitation, physiological data such as heart rate and blood pressure, and industrial data such as sensor data and machine vibration data. Note that there is no limitation on the time-series signals here. The audio data may be referred to as an audio signal. A moving image may be referred to as an image signal, a moving image signal, a video signal, or the like.

For example, the acceptance unit 12 accepts two or more of the time-series signals described below. For example, the acceptance unit 12 accepts the two or more time-series signals described below in the same time period. The two or more time-series signals are audio data from multiple microphones, video from multiple cameras, trend data on stock prices of multiple companies, trend data on exchange rates between a currency and two or more other currencies, and trend data on multiple physiological data of a single person (for example, body temperature, heart rate, and blood pressure).

Examples of the two or more time-series signals accepted by the acceptance unit 12 include sound signals generated from two or more sound sources installed at different positions.

Here, the “acceptance” is a concept that includes, for example, acceptance of information input from an input device such as a microphone, a keyboard, a mouse, or a touch panel, reception of information transmitted via a wired or wireless communication network, or acceptance of information read out from a recording medium such as an optical disk, a magnetic disk, or a semiconductor memory.

The processing unit 13 performs various kinds of processing. Examples of the various kinds of processing include processing performed by the information acquisition unit 131, processing performed by the frequency conversion unit 132, processing performed by the signal transmission unit 133, and processing performed by the learning unit 134.

The information acquisition unit 131 acquires, for each of the two or more buffering times, information having a time length corresponding to the buffering time from the time-series signal accepted by the acceptance unit 12. The information acquisition unit 131 typically temporarily accumulates, for each of the two or more buffering times, the acquired information in the buffer 113 corresponding to the buffering time. For example, the information acquisition unit 131 extracts, for each of the two or more buffering times, information from the time-series signal, using a window function of a time width indicated by the buffering time. Note that “for each of the two or more buffering times” may be considered to be equivalent to “for each of the two or more buffers 113”. In this case, two or more buffers 113 may correspond to one buffering time.

The information acquisition unit 131 may acquire, for each of the two or more time-series signals accepted by the acceptance unit 12 and for each of the two or more buffering times, information having a time length corresponding to the buffering time from the time-series signal.

It is preferable that the above-mentioned two or more buffering times are preferably, for example, three or more buffering times. For example, it is preferable that three buffering times of the three or more buffering times respectively have time lengths corresponding to long-term, medium-term, and short-term time scales. The time lengths corresponding to the long-term, medium-term, and short-term time scales are, for example, time lengths respectively corresponding to the time scales corresponding to bushy cells, stellate cells, and octopus cells included in the auditory nerves of living organisms, including humans. The time scale of bushy cells is on the order of milliseconds (typically within a few milliseconds). The time scale of stellate cells is tens to hundreds of milliseconds. The time scale of octopus cells is from a few hundred microseconds to a few milliseconds.

The frequency conversion unit 132 performs, for each of the two or more buffering times, frequency conversion on each piece of information acquired by the information acquisition unit 131 to acquire an image. Two or more images may be acquired for each buffering time. The frequency conversion algorithm may be, for example, a fast Fourier transform (FFT), a short-time Fourier transform (STFT), a wavelet transform, a Wigner-Ville distribution, or the like, but there is no limitation.

The signal transmission unit 133 passes, for each of the two or more buffering times, the image acquired by the frequency conversion unit 132 and corresponding to the buffering time to the neural network, and acquires output information output from the neural network. The output information output from the neural network may be output information that is based on a signal output from the neural network. Note that the signal may be considered as information.

For example, the signal transmission unit 133 acquires, for each of the two or more buffering times, a feature vector of the image acquired by the frequency conversion unit 132, provides the feature vector to the input layer of the neural network, propagates a signal within the neural network, and acquires output information that is based on the signal output from the output layer of the neural network. Note that passing an image to the neural network typically means passing a feature vector of the image to the neural network. Since the signal propagation processing within the neural network is a known technique, a detailed description thereof will be omitted.

Note that a feature vector of an image is a set of image features. Examples of image features constituting a feature vector include a color feature, a shape feature, a texture feature, and so on, but there are no limitation. The technique for acquiring a feature vector from an image is a known technique.

For example, the signal transmission unit 133 passes, for each of the two or more buffering times, the image acquired by the frequency conversion unit 132 to one neural network, and acquires output information that is based on the signal output from the one neural network. Note that the neural network here is the neural network in the NN storage unit 112.

For example, the signal transmission unit 133 passes, for each of the two or more buffering times, the image acquired by the frequency conversion unit 132 to a sub-neural network corresponding to the buffering time, and acquires output information that is based on signals output from the two or more sub-neural networks. Here, for example, the signal transmission unit 133 may acquire one piece of output information based on pieces of output information from the two or more sub-neural networks. The sub-neural networks are the neural networks in the SNN storage unit 111.

The output information is information that is output. For example, the output information includes one or more pieces of information among the following: a frequency analysis result for an audio signal, a voice recognition result for an audio signal, a sound source separation result for an audio signal, and a sound source direction estimation result for an audio signal. However, there is no limitation on the output information.

The learning unit 134 passes, for each of the two or more buffering times, an image acquired by the frequency conversion unit 132 and corresponding to the buffering time, to a sub-neural network corresponding to the buffering time, and updates each of the two or more sub-neural networks. For example, the learning unit 134 accumulates the two or more updated sub-neural networks in the SNN storage unit 111.

Also, for example, the learning unit 134 merges the two or more updated sub-neural networks to form one neural network. For example, the learning unit 134 accumulates the formed neural network in the NN storage unit 112.

Note that the sub-neural networks are updated through neural network learning processing. The update of the sub-neural networks is, for example, processing performed to change the weight of an edge, or processing performed to change the probability that a node will fire. The more frequently a signal passes through an edge, the greater the weight of the edge typically becomes. When there are many occasions or long periods in which a signal does not pass through an edge, for example, the weight of the edge becomes smaller. The more a node fires, the greater the probability that the node will fire. When there are many occasions or long periods in which a node does not fire, for example, the probability that the node will fire becomes smaller. Note that the processing performed by the learning unit 134 is a known technique. The processing performed by the learning unit 134 is, for example, deep learning processing.

The merging of the two or more sub-neural networks is typically processing in which edges are generated to connect adjacent nodes between the two or more adjacent sub-neural networks, thereby connecting the two or more sub-neural networks. Note that there is no limitation on the method for connecting the two or more sub-neural networks.

The output unit 14 outputs various kinds of information. The various kinds of information are pieces of output information, which will be described later. Here, “output” is a concept that encompasses displaying on a display screen, projection using a projector, printing by a printer, the output of a sound, transmission to an external apparatus, accumulation on a recording medium, delivery of a processing result to another processing apparatus or another program, and the like.

The information output unit 135 outputs one or more pieces of output information acquired by the signal transmission unit 133. The information output unit 135 outputs, for example, two or more pieces of output information acquired by the signal transmission unit 133, or one piece of output information that is based on the two or more pieces of output information acquired by the signal transmission unit 133.

The storage unit 11, the SNN storage unit 111, the NN storage unit 112, and the buffers 113 are preferably non-volatile recording media, but may also be realized as volatile recording media.

There is no limitation on the process in which information is stored in the storage unit 11 or the like. For example, information may be stored in the storage unit 11 or the like via a recording medium, or information transmitted via a communication line or the like may be stored in the storage unit 11 or the like, or information input via an input device may be stored in the storage unit 11 or the like.

The acceptance unit 12 is preferably realized by a device driver for an input means such as a microphone, a touch panel, or a keyboard, control software for a menu screen, or a wireless or wired communication means, but can also be realized using a broadcast receiving means or the like.

The processing unit 13, the information acquisition unit 131, the frequency conversion unit 132, the signal transmission unit 133, and the learning unit 134 can typically be realized using a processor, a memory, and the like. The processing procedures performed by the processing unit 13 and so on are typically realized using software, and the software is recorded on a recording medium such as a ROM. However, such processing procedures may be realized using hardware (a dedicated circuit). Note that the processor may be a CPU, an MPU, a GPU, or the like, and there is no limitation on the type thereof.

The output unit 14 and the information output unit 135 can be realized using driver software for an output device such as a display or a speaker, or by a driver software for an output device and the output device, or the like. The output unit 14 may be realized using a wireless or wired communication means.

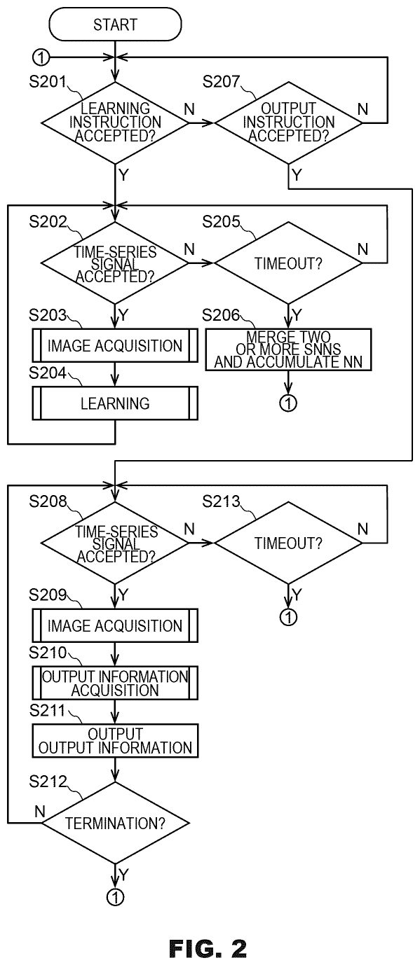

Next, examples of the operation of the signal processing apparatus 1 will be described with reference to the flowchart in FIG. 2.

(Step S201) The acceptance unit 12 judges whether or not a learning instruction has been accepted. If the learning instruction has been accepted, processing proceeds to step S202, and otherwise processing proceeds to step S207.

(Step S202) The acceptance unit 12 judges whether or not a time-series signal for learning processing has been accepted. If a time-series signal has been accepted, processing proceeds to step S203, and otherwise processing proceeds to step S205. Here, for example, it is assumed that the acceptance unit 12 accepts a learning instruction and then sequentially accepts time-series signals.

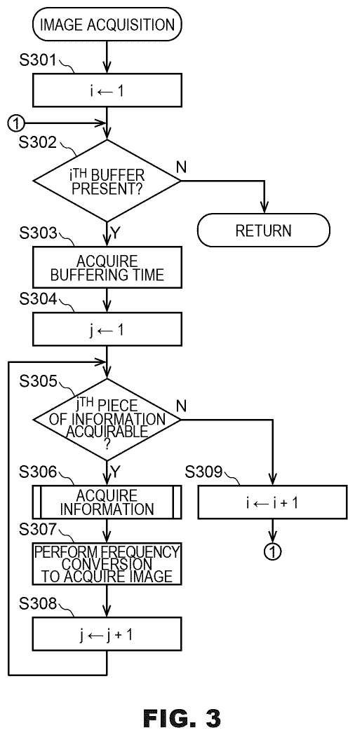

(Step S203) The processing unit 13 performs image acquisition processing on each of the two or more buffers 113. An example of image acquisition processing will be described with reference to the flowchart in FIG. 3.

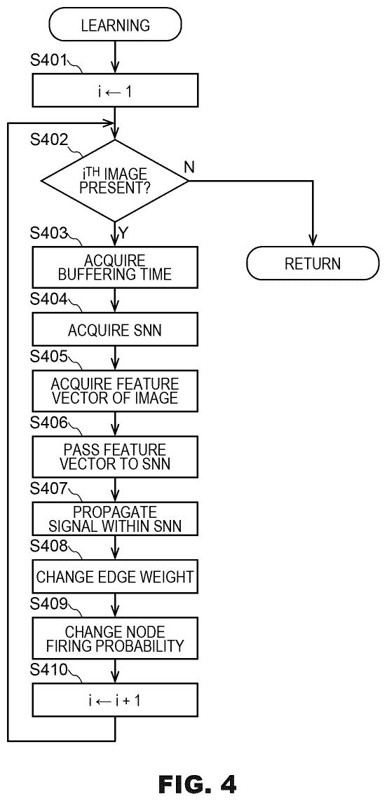

(Step S204) The learning unit 134 performs learning processing. Processing returns to step S202. An example of learning processing will be described with reference to the flowchart in FIG. 4.

(Step S205) The processing unit 13 judges whether or not a timeout has occurred. If a timeout has occurred, processing proceeds to step S206, and otherwise processing returns to step S202. Note that, for example, if a predetermined time or more has elapsed after a time-series signal was accepted, the processing unit 13 judges that a timeout has occurred.

(Step S206) The learning unit 134 merges the two or more SNNs updated through learning processing to form one NN, and stores the NN in the NN storage unit 112. Processing returns to step S201.

(Step S207) The acceptance unit 12 judges whether or not an output instruction has been accepted. If an output instruction has been accepted, processing proceeds to step S208, and otherwise processing returns to step S201.

(Step S208) The acceptance unit 12 judges whether or not a time-series signal for output information acquisition processing has been accepted. If a time-series signal has been accepted, processing proceeds to step S209, and otherwise processing proceeds to step S213. Here, for example, it is assumed that the acceptance unit 12 accepts an output instruction and then sequentially accepts time-series signals.

(Step S209) The processing unit 13 performs image acquisition processing for each buffer 113. An example of image acquisition processing will be described with reference to the flowchart in FIG. 3.

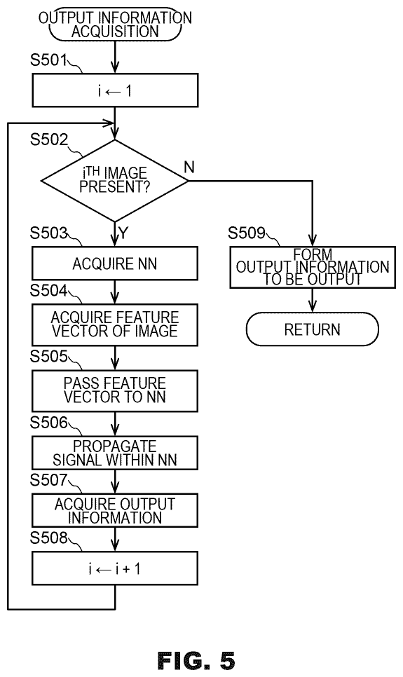

(Step S210) The processing unit 13 performs output information acquisition processing. An example of output information acquisition processing will be described with reference to the flowcharts in FIGS. 5, 6, and 7.

(Step S211) The information output unit 135 outputs output information.

(Step S212) The processing unit 13 judges whether or not to terminate processing. If processing is to be terminated, processing returns to step S201, and otherwise processing returns to step S208. Note that, for example, processing is to be terminated when a termination instruction is accepted.

(Step S213) The processing unit 13 judges whether or not a timeout has occurred. If a timeout has occurred, processing returns to step S201, and otherwise processing returns to step S208. Note that, for example, the processing unit 13 judges that a timeout has occurred when a predetermined time or more has elapsed after a time-series signal was accepted.

Note that, in the flowchart in FIG. 2, processing is terminated when power is turned off or an interruption is made to terminate the processing.

Next, an example of the image acquisition processing in steps S203 and S209 will be described with reference to the flowchart in FIG. 3.

(Step S301) The information acquisition unit 131 substitutes 1 for a counter i.

(Step S302) The information acquisition unit 131 judges whether or not an i^{th} buffer 113 is present. If the i^{th} buffer 113 is present, processing proceeds to step S303, and otherwise processing returns to the higher level processing. Note that the judgment as to whether or not the i^{th} buffer 113 is present may be considered to be the same as the judgment as to whether or not the i^{th} buffering time is present.

(Step S303) The information acquisition unit 131 acquires the buffering time corresponding to the i^{th} buffer 113.

(Step S304) The information acquisition unit 131 substitutes 1 for a counter j.

(Step S305) The information acquisition unit 131 judges whether or not a j^{th} piece of information having the length indicated by the buffering time acquired in step S303 can be acquired from the accepted time-series signal. If the j^{th} piece of information can be acquired, processing proceeds to step S306, and otherwise processing proceeds to step S309.

(Step S306) The information acquisition unit 131 acquires the j^{th} piece of information having the length indicated by the buffering time acquired in step S303 from the accepted time-series signal, and temporarily accumulates the acquired information in the i^{th} buffer 113.

(Step S307) The frequency conversion unit 132 performs frequency conversion on the information acquired in step S306 to acquire an image, and temporarily accumulates the image in the i^{th} buffer 113 or a buffer not shown.

(Step S308) The information acquisition unit 131 increments the counter j by 1. Processing returns to step S305.

(Step S309) The information acquisition unit 131 increments the counter i by 1. Processing returns to step S302.

Next, an example of the learning processing in step S204 will be described with reference to the flowchart in FIG. 4.

(Step S401) The learning unit 134 substitutes 1 for a counter i.

(Step S402) The learning unit 134 judges whether or not an i^{th} image is present in the images temporarily accumulated in the buffer.

(Step S403) The learning unit 134 acquires the buffering time corresponding to the i^{th} image.

(Step S404) The learning unit 134 acquires the SNN corresponding to the i^{th} image from the SNN storage unit 111.

(Step S405) The learning unit 134 acquires a feature vector of the i^{th} image.

(Step S406) The learning unit 134 passes the feature vector acquired in step S405 to the SNN acquired in step S404.

(Step S407) The learning unit 134 propagates a signal within the SNN.

(Step S408) The learning unit 134 updates the weight of each of one or more edges in the SNN in response to the propagation of signals within the SNN.

(Step S409) The learning unit 134 updates the firing probability of one or more nodes in the SNN in response to the signal propagation within the SNN.

(Step S410) The learning unit 134 increments the counter i by 1. Processing returns to step S402.

In the flowchart in FIG. 4, it is preferable that the learning unit 134 updates the weight of one or more edges and updates the firing probability of one or more nodes while propagating a signal within the SNN.

Next, a first example of the output information acquisition processing in step S210 will be described with reference to the flowchart in FIG. 5. The first example of the output information acquisition processing is a case where there is one NN to which images corresponding to the two or more buffers 113 are to be passed. Note that the NN here is, for example, the NN formed through the operation described using the flowchart in FIG. 4.

(Step S501) The signal transmission unit 133 substitutes 1 for a counter i.

(Step S502) The signal transmission unit 133 judges whether or not the i^{th} image is present in the temporarily accumulated images. If the i^{th} image is present, processing proceeds to step S503, and otherwise processing proceeds to step S510.

(Step S503) The signal transmission unit 133 acquires the NN from the NN storage unit 112.

(Step S504) The signal transmission unit 133 acquires the feature vector of the i^{th} image.

(Step S505) The signal transmission unit 133 passes the feature vector acquired in step S504 to the NN acquired in step S503.

(Step S506) The signal transmission unit 133 propagates a signal within the NN acquired in step S503.

(Step S507) The signal transmission unit 133 acquires output information based on a signal output from the output layer of the NN.

(Step S508) The signal transmission unit 133 increments the counter i by 1. Processing returns to step S502.

(Step S509) The signal transmission unit 133 forms output information to be output based on the two or more pieces of output information acquired in step S507. Processing returns to the higher level processing.

In the flowchart in FIG. 5, the signal transmission unit 133 acquires output information for each image acquired by the frequency conversion unit 132. The acquisition of output information for each image may be considered as the acquisition of output information for each buffering time corresponding to the image.

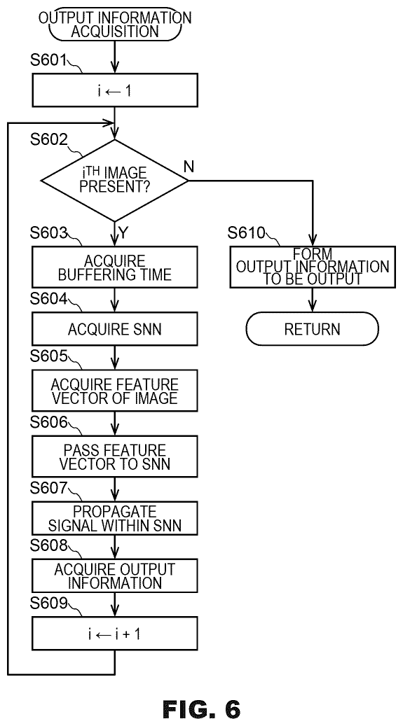

Next, a second example of the output information acquisition processing in step S210 will be described with reference to the flowchart in FIG. 6. The second example of the output information acquisition processing is a case where the output information is formed using output information that is based on signals from the two or more SNNs.

(Step S601) The signal transmission unit 133 substitutes 1 for a counter i.

(Step S602) The signal transmission unit 133 judges whether or not an i^{th} image is present in the temporarily accumulated images. If the i^{th} image is present, processing proceeds to step S603, and otherwise processing proceeds to step S610.

(Step S603) The signal transmission unit 133 acquires the buffering time corresponding to the i^{th} image.

(Step S604) The signal transmission unit 133 acquires the SNN corresponding to the buffering time acquired in step S603 from the SNN storage unit 111.

(Step S605) The signal transmission unit 133 acquires a feature vector of the i^{th} image.

(Step S606) The signal transmission unit 133 passes the feature vector acquired in step S605 to the SNN acquired in step S604.

(Step S607) The signal transmission unit 133 propagates the signal within the SNN acquired in step S604.

(Step S608) The signal transmission unit 133 acquires output information corresponding to the i^{th} image based on a signal from the output layer resulting from the signal propagation within the SNN.

(Step S609) The signal transmission unit 133 increments the counter i by 1. Processing returns to step S602.

(Step S610) The signal transmission unit 133 configures output information to be output based on the two or more pieces of output information acquired in step S608. Processing returns to the higher level processing. Note that the output information to be output may be any information that is based on the two or more pieces of output information acquired in step S608. Examples of the output information to be output include information that contains the two or more pieces of output information without change, information formed by merging the two or more pieces of output information into one piece of information, and information obtained by providing the two or more pieces of output information to a function and executing the function.

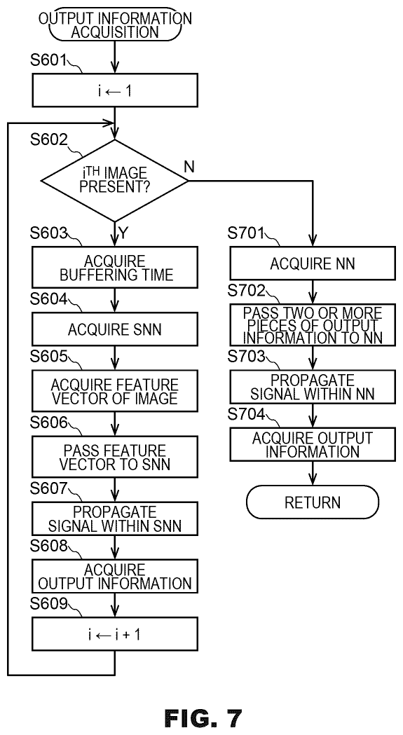

Next, a third example of the output information acquisition processing in step S210 will be described with reference to the flowchart in FIG. 7. In the flowchart in FIG. 7, the description of the same steps as those in the flowchart in FIG. 6 will be omitted. The third example of the output information acquisition processing is a case where output information that is based on the two or more SNNs is given to the one NN to acquire the output information to be output.

(Step S701) The signal transmission unit 133 acquires the NN from the NN storage unit 112.

(Step S702) The signal transmission unit 133 passes the two or more pieces of output information acquired in step S608 to the NN acquired in step S701. Note that there is no limitation on the method for passing the two or more pieces of output information to the NN. The signal transmission unit 133 may sequentially transmit the two or more pieces of output information to the NN, or the signal transmission unit 133 may transmit one piece of information that is based on the two or more pieces of output information to the NN. Note that examples of passing a piece of information that is based on the two or more pieces of output information to the NN include passing a piece of information formed by merging the two or more pieces of output information to the NN, passing a piece of information obtained by performing a calculation on the two or more pieces of output information to the NN, and passing a piece of information obtained by searching a database (not shown) using the two or more pieces of output information as a key to the NN.

(Step S703) The signal transmission unit 133 propagates a signal within the NN acquired in step S701.

(Step S704) The signal transmission unit 133 acquires output information based on a signal from the output layer resulting from the signal propagation within the NN. Processing returns to the higher level processing.

In the flowcharts in FIGS. 5 to 7, when the signal transmission unit 133 propagates a signal within the NN or the SNNs, learning processing such as updating edge weights and node firing probabilities may also be performed.

Hereinafter, specific examples of the outline of the operation of the signal processing apparatus 1 according to the present embodiment will be described.

### Specific Example 1

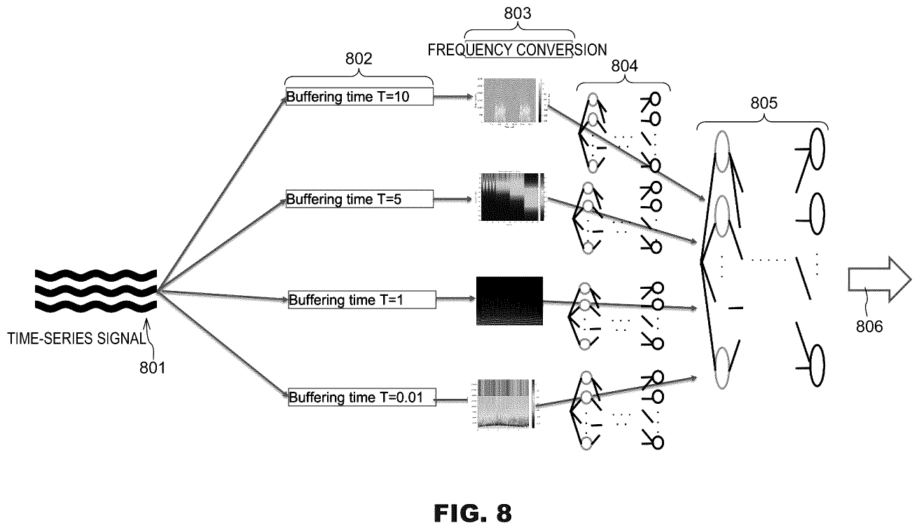

A specific example of the operation of the signal processing apparatus 1 will be described with reference to the schematic diagram of the specific operation of the signal processing apparatus 1 shown in FIG. 8.

First, the acceptance unit 12 of the signal processing apparatus 1 accepts a time-series signal (801 in FIG. 8). Here, the storage unit 11 of the signal processing apparatus 1 includes four buffers 113 with the respective buffering times of “T=10, 5, 1, 0.01” (802).

The information acquisition unit 131 acquires, for each of the four buffers 113, information from a time-series signal, using a window function corresponding to the buffering time. It is preferable that the processing for the four buffers 113 is performed in parallel.

Next, for each of the four buffers 113, the frequency conversion unit 132 performs frequency conversion on the information sequentially acquired by the information acquisition unit 131, and sequentially acquires images (803). It is preferable that the frequency conversion processing for the buffers 113 (for the buffering times) is also performed in parallel.

Next, the signal transmission unit 133 acquires, for each of the four buffers 113, an SNN corresponding to the buffer 113 from the SNN storage unit 111, sequentially provides the feature vectors of the image acquired by the frequency conversion unit 132 to the SNN corresponding to the buffer 113, propagates a signal to the SNN, and acquires output information for the SNN (804). It is preferable that the signal propagation processing within the SNNs in 804 in FIG. 8 is performed in parallel.

Next, the signal transmission unit 133 acquires one NN from the NN storage unit 112, passes output information that is the output from the two or more SNNs to the one NN, propagates the signal within the one NN, and acquires output information that is based on the signal from the one NN (805). It is preferable that the signal propagation processing within the NN in 805 in FIG. 8 is performed in parallel.

Next, the information output unit 135 outputs the output information based on the output from the one NN acquired by the signal transmission unit 133 (806).

### Specific Example 2

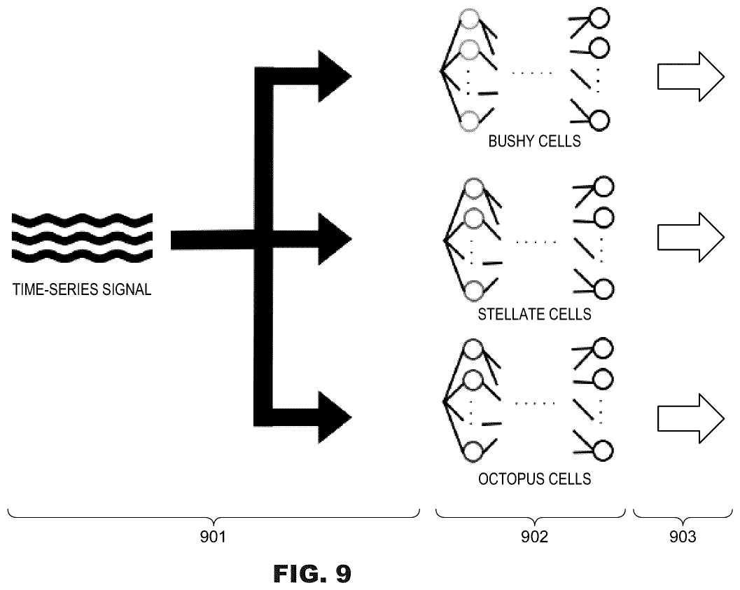

A specific example of the operation of the signal processing apparatus 1 will be described with reference to the schematic diagram of the specific operation of the signal processing apparatus 1 shown in FIG. 9.

First, the acceptance unit 12 of the signal processing apparatus 1 accepts a time-series signal. Here, the storage unit 11 of the signal processing apparatus 1 has three buffers 113 for buffering times (T1 for emulating bushy cells, T2 for emulating stellate cells, and T3 for emulating octopus cells).

The information acquisition unit 131 acquires, for each of the three buffers 113, information from a time-series signal, using a window function corresponding to the buffering time thereof. It is preferable that the processing for the three buffers 113 is performed in parallel.

Next, for each of the three buffers 113, the frequency conversion unit 132 performs frequency conversion on the information sequentially acquired by the information acquisition unit 131, and sequentially acquires images. It is preferable that the frequency conversion processing for the buffers 113 (for the buffering times) is also performed in parallel. The above processing is illustrated in 901 in FIG. 9.

Next, the signal transmission unit 133 acquires, for each of the three buffers 113, the SNN corresponding to the buffer 113 (903 in FIG. 9) from the SNN storage unit 111, sequentially provides the feature vector of the image acquired by the frequency conversion unit 132 to the SNN corresponding to the buffer 113, and propagates the signal to the SNN, thereby obtaining output information for the SNNs (903).

Thereafter, the information output unit 135 may output the three pieces of output information for the SNNs without change, or may output one piece of output information that is based on the three pieces of output information. Furthermore, as described in Specific Example 1, the signal transmission unit 133 may acquire one NN from the NN storage unit 112, pass the output information output from each of the three SNNs to the one NN, propagate signals within the one NN, and acquire output information from the one NN, and the information output unit 135 may output the output information.

As described above, according to the present embodiment, it is possible to appropriately perform both the time domain analysis and the frequency domain analysis on a time-series signal.

Also, according to the present embodiment, by using a model that is based on the auditory nerve system of living organisms, it is possible to more appropriately perform both time domain analysis and frequency domain analysis on a time-series signal.

Furthermore, according to the present embodiment, any one of the frequency analysis result, the voice recognition result, the sound source separation result, and the sound source direction estimation result can be output for a time-series voice signal.

Note that the processing in the present embodiment may be realized using software. This software may be distributed through software downloading or the like. Also, this software may be recorded on a recording medium such as a CD-ROM and distributed. Note that the same applies to the other embodiments in the present description. Note that the software that realizes the signal processing apparatus 1 according to the present embodiment is the program described below. That is to say, this program is a program that enables a computer to function as: an acceptance unit that accepts a time-series signal; an information acquisition unit that, for each buffering time of two or more buffering times, acquires information having a time length corresponding to the buffering time from the time-series signal; a frequency conversion unit that, for each buffering time of the two or more buffering times, performs frequency conversion on the information acquired by the information acquisition unit to acquire an image; a signal transmission unit that, for each buffering time of the two or more buffering times, passes the image acquired by the frequency conversion unit to a neural network, and acquires output information that is based on a signal output from the neural network; and an information output unit that outputs the output information.

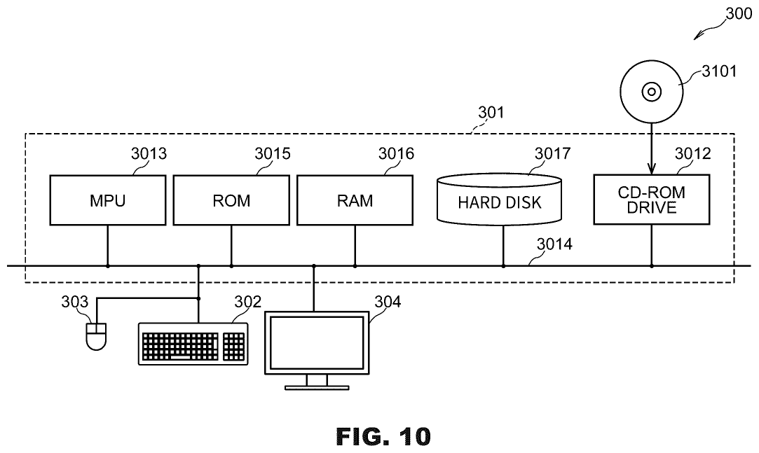

FIG. 10 is a block diagram of a computer system 300 that executes the programs described in this specification to realize the signal processing apparatus 1 and so on according to the various embodiments described above.

In FIG. 10, the computer system 300 includes a computer 301 that includes a CD-ROM drive, a keyboard 302, a mouse 303, and a monitor 304.

In FIG. 10, the computer 301 includes, in addition to a CD-ROM drive 3012, an MPU 3013, a bus 3014 that is connected to the CD-ROM drive 3012 and so on, a ROM 3015 for storing programs such as a boot-up program, a RAM 3016 that is connected to the MPU 3013 and is used to temporarily store application program instructions and provide a temporary storage space, and a hard disk 3017 for storing application programs, system programs, and data. Here, although not shown in the figure, the computer 301 may further include a network card that provides connection to a LAN.

The program that enables the computer system 300 to perform the functions of the signal processing apparatus 1 and so on according to the above-described embodiments may be stored in the CD-ROM 3101, inserted into the CD-ROM drive 3012, and furthermore transferred to the hard disk 3017. Alternatively, the program may be transmitted to the computer 301 via a network (not shown) and stored on the hard disk 3017. The program is loaded into the RAM 3016 when the program is to be executed. The program may be directly loaded from the CD-ROM 3101 or the network.

The program does not necessarily have to include an operating system (OS), a third party program, or the like that enables the computer 301 to perform the functions of the signal processing apparatus 1 and so on according to the embodiments described above. The program need only contain the part of the instruction that calls an appropriate function (module) in a controlled manner to achieve a desired result. How the computer system 300 works is well known and the detailed descriptions thereof will be omitted.

In the above-described program, the step of transmitting information, the step of receiving information and so on do not include processing performed by hardware, for example, processing performed by a modem or an interface card in the step of transmitting (processing that can only be performed by hardware).

There may be a single or multiple computers executing the above-described program. That is to say, centralized processing or distributed processing may be performed.

Also, as a matter of course, in each of the above-described embodiments, two or more communication means that are present in one device may be physically realized using one medium.

Also, in the above-described embodiments, each kind of processing may be realized as centralized processing that is performed by a single device, or distributed processing that is performed by multiple devices.

As a matter of course, the present invention is not limited to the above-described embodiments, and various changes are possible, and such variations are also included within the scope of the present invention.

### INDUSTRIAL APPLICABILITY

As described above, the signal processing apparatus 1 according to the present invention has the effect of being able to appropriately perform both time domain analysis and frequency domain analysis, and is useful, for example, as a signal processing apparatus that processes audio signals.

### REFERENCE SIGNS LIST

1 Signal Processing Apparatus
11 Storage Unit
12 Acceptance Unit
13 Processing Unit
14 Output Unit
111 SNN Storage Unit
112 NN Storage Unit
113 Buffer
131 Information Acquisition Unit
132 Frequency Conversion Unit
133 Signal Transmission Unit
134 Learning Unit
135 Information Output Unit

What is claimed is:

1. A signal processing apparatus comprising:
an acceptance unit that accepts a time-series signal;
an information acquisition unit that, for each buffering time of two or more buffering times, acquires information having a time length corresponding to the buffering time from the time-series signal;
a frequency conversion unit that, for each buffering time of the two or more buffering times, performs frequency conversion on the information acquired by the information acquisition unit to acquire an image;
a signal transmission unit that, for each buffering time of the two or more buffering times, passes the image acquired by the frequency conversion unit to a neural network, and acquires output information that is based on a signal output from the neural network; and
an information output unit that outputs the output information.

2. The signal processing apparatus according to claim 1, further comprising:
a learning unit that, for each buffering time of the two or more buffering times, passes the image acquired by the frequency conversion unit to a sub neural network corresponding to the buffering time, updates the two or more sub neural networks, and merges the two or more updated sub-neural networks to form one neural network,
wherein, for each buffering time of the two or more buffering times, the signal transmission unit passes the image acquired by the frequency conversion unit to the one neural network, and acquires output information acquired from the one neural network.

3. The signal processing apparatus according to claim 1,
wherein, for each buffering time of the two or more buffering times, the signal transmission unit passes the image acquired by the frequency conversion unit to a neural network for the buffering time, and acquires output information output from the two or more neural networks, and
the information output unit outputs the two or more pieces of output information acquired by the signal transmission unit or one piece of output information that is based on the two or more pieces of output information acquired by the signal transmission unit.

4. The signal processing apparatus according to claim 3,
wherein, for each buffering time of the two or more buffering times, the signal transmission unit passes the image acquired by the frequency conversion unit to a sub neural network for the buffering time, acquires output information output from the two or more sub neural networks, passes the two or more pieces of output information to the one neural network, and acquires output information output from the neural network, and
the information output unit outputs the output information acquired by the signal transmission unit.

5. The signal processing apparatus according to claim 1,
wherein the acceptance unit accepts two or more time-series signals,
for each time-series signal of the two or more time-series signals, and for each buffering time of the two or more buffering times, the information acquisition unit acquires information having a time length corresponding to the buffering time from the time-series signal, and
for each buffering time of the two or more buffering times, the frequency conversion unit performs frequency conversion on the information acquired by the information acquisition unit to acquire an image.

6. The signal processing apparatus according to claim 1,
wherein the two or more buffering times are three or more buffering times, and three buffering times of the three or more buffering times respectively have time lengths corresponding to long-term, medium-term, and short-term time scales.

7. The signal processing apparatus according to claim 1,
wherein the time-series signal is an audio signal, and
the output information includes one of: a frequency analysis result for the audio signal; a voice recognition result for the audio signal; a sound source separation result for the audio signal; and a sound source direction estimation result for the audio signal.

8. A signal processing method realized using an acceptance unit, an information acquisition unit, a frequency conversion unit, a signal transmission unit, and an information output unit, the signal processing method comprising:
an acceptance step in which the acceptance unit accepts a time-series signal;
an information acquisition step in which, for each buffering time of two or more buffering times, the information acquisition unit acquires information having a time length corresponding to the buffering time from the time-series signal;
a frequency conversion unit step in which, for each buffering time of the two or more buffering times, the frequency conversion unit performs frequency conversion on the information acquired by the information acquisition unit to acquire an image;
a signal transmission step in which, for each buffering time of the two or more buffering times, the signal transmission unit passes the image acquired by the frequency conversion unit to a neural network, and acquires output information that is based on a signal output from the neural network; and
an information output step in which the information output unit outputs the output information.

9. A recording medium having recorded thereon a program for enabling a computer to function as:
an acceptance unit that accepts a time-series signal;
an information acquisition unit that, for each buffering time of two or more buffering times, acquires information having a time length corresponding to the buffering time from the time series signal;
a frequency conversion unit that, for each buffering time of the two or more buffering times, performs frequency conversion on the information acquired by the information acquisition unit to acquire an image;
a signal transmission unit that, for each buffering time of the two or more buffering times, passes the image acquired by the frequency conversion unit to a neural network, and acquires output information that is based on a signal output from the neural network; and
an information output unit that outputs the output information.
